(19) United States
(12) Patent Application Publication
(10) Pub. No.: US 2005/0252335 A1
(43) Pub. Date: Nov. 17, 2005

(54) Linear ratchet apparatus

(75) Inventors: Brian A. Moody, Melbourne Beach, FL (US); Robert J. Fangmeier, West Melbourne, FL (US)

Correspondence Address: Donald S. Showalter, Esq.;Holland & Knight LLP, Suite 1300, One East Broward Boulevard, Fort Lauderdale, FL, 33301, US

(73) Assignee: Harris Corporation

(21) Appl. No.: 10/843,261

(22) Filed: May 11, 2004

(51) Int. Cl. E05B 3/00

(52) U.S. Cl. 74/578

(57) ABSTRACT

A linear ratchet apparatus has a toothed rack mounted for linear movement along an axis defining a forward direction and a reverse direction. A number of latches mutually spaced at intervals in a direction parallel to the axis are mounted for linear reciprocation perpendicular to the axis and are forcibly biased into contact with the teeth of the rack. The mating surfaces of the teeth and latches are shaped such that in normal operation, the latches override the teeth allowing the rack to be moved in the forward direction. Shear engagement between at least one of the latches and at least one of the teeth limits reverse travel of the rack to not more than a predetermined maximum backlash distance which can be specified as desired based on the number and spacing of the latches and the width of the teeth of the rack. A release member coupled to the latches can be actuated to enable reverse movement of the rack.

### STATEMENT REGARDING FEDERALLY SPONSORED-RESEARCH OR DEVELOPMENT

The subject invention was developed under a United States Government contract. The Government of the United States has rights in the invention in accordance with 48 C.F.R. 52.227.12.

### CROSS-REFERENCE TO RELATED APPLICATIONS

Not Applicable.

### INCORPORATION BY REFERENCE OF MATERIAL SUBMITTED ON A COMPACT DISC

Not Applicable.

### FIELD OF THE INVENTION

The invention relates to the field of mechanical ratchet mechanisms.

More particularly, the present invention relates to a linear ratchet apparatus capable of free travel with low drag in a forward linear direction while stopping motion in the reverse direction with high load capacity and arbitrarily low backlash.

### BACKGROUND OF THE INVENTION

Ratchet mechanisms are useful for providing relatively free movement in one direction while preventing movement in the opposite direction unless and until a release is activated. A classic mechanism for providing unidirectional rotary motion is a rotary ratchet mechanism of the type in which a pivotable pawl or “dog” contacts, either under the force of gravity or spring pressure, the circumference of a rotatable gear. The pawl and teeth are shaped such that as the gear rotates in one angular direction, the pawl rides freely over the teeth of the gear to allow substantially free rotation of the gear. Upon reversing the direction of the gear, the pawl at some point engages one of the teeth to prevent further motion in the reverse direction unless and until the pawl is pivoted out of engagement with the tooth.

Unidirectional linear motion may be obtained by adding to the rotary ratchet mechanism just described, a linear rack having teeth which mate with those on the rotatable gear. The rotatable gear thus serves as a pinion whose rotation in one angular direction causes linear translation of the rack in a forward linear direction. Rotation of the gear in the reverse direction is prevented by the pawl. Translation of the rack in the reverse linear direction can occur only after the pawl is disengaged from the gear.

A limitation of the prior art mechanisms just described is that their resolution tends to be inversely proportional to their load capacity in the reverse or “locking” direction. Each tooth of the gear occupies an angular interval which must be transversed by the pawl before reaching the location at which its engagement with the next adjacent tooth can positively stop motion in the reverse direction. Just before reaching that location on a given tooth, the gear can move in the reverse direction until the pawl engages the corresponding stop location of the prior tooth. That reverse angular rotation of the gear, or in the case of a rack and pinion mechanism, the corresponding reverse linear travel of the rack engaged by the gear which can occur before reverse movement is stopped, is known as “backlash”. A high resolution mechanism is one exhibiting low backlash. Conversely, as backlash increases, resolution is degraded. As used herein, the terms “resolution” and “maximum backlash” used interchangeably with both referring to units of distance.

Resolution of the prior art mechanisms described above can be increased by decreasing the size of the teeth of the rotating gear, and in the case of a rack and pinion mechanism, correspondingly decreasing the sizes of the mating teeth on the rack. However, as teeth of a given material are reduced in size, they become progressively weaker. Thus, higher resolution is gained at the expense of the capacity of the mechanism to resist load forces in the reverse, locking direction.

The use of a rotating gear and pivoting pawl also imposes constraints on the minimum size of such mechanisms. The need to allow sufficient space to accommodate both the rotational envelope of the gear and the arc transversed by the pivoting pawl limits the degree to which such mechanisms can be miniaturized while remaining capable of meeting the reverse load requirements of a given application.

### SUMMARY OF THE INVENTION

The invention provides a linear ratchet mechanism capable of providing travel with low drag in one linear direction while stopping motion in the opposite direction with resolution which can be selected to meet the requirements of a given application without diminishing reverse load capacity.

A preferred embodiment includes a toothed rack which is received within a housing and mounted for linear movement relative to the housing along an axis which defines a forward direction and a reverse direction. A number of latches capable of engaging the teeth of the rack are also located within the housing. The latches are mutually spaced from one another and are located at intervals in a direction parallel to the axis. Each latch is mounted for reciprocation toward and away from the axis of travel of the rack along a linear path which intersects that axis, preferably perpendicularly. The latches are forcibly biased into contact with the teeth of the rack by springs interposed between the latches and an interior wall of the housing. The teeth and latches are shaped so that as the rack is moved in the forward direction, the teeth slide readily past the latches. However, when the rack is moved in the reverse direction, at least one of the latches engages a tooth of the rack in shear to arrest the rack against any further movement in the reverse direction. The number and spacing of the latches and the width of the teeth on the rack are selected such that backlash is limited to a predetermined distance. Higher resolution can be achieved by scaling the design to include a greater number of latches thereby decreasing the maximum backlash without reducing the reverse load capacity of the apparatus.

According to an alternative embodiment, groups of one or more latches are mounted angularly offset from one another with respect to the axis of travel of the rack. In order to minimize or reduce the overall dimension of the apparatus in the axial direction, such groups can be positioned to span wholly or partially overlapping regions of the axis of travel.

The rack can be selectively released so it is free to travel in either the forward or reverse direction. For that purpose, each embodiment preferably includes a release member mechanically coupled to each of the latches for applying force to the latches for overcoming the biasing force so the latches can move away from the axis a distance sufficient to clear the teeth of the rack. In a preferred form, the latches each include an aperture and the release member takes the form of a pin passing through the aperture of each latch.

These and other aspects and advantages of the invention will become more apparent to a person of ordinary skill in the art upon review of the following detailed written description of preferred embodiments, taken in conjunction with the appended drawings in which like reference numerals designate like items.

### BRIEF DESCRIPTION OF THE DRAWINGS

FIG. 1 is a perspective view of a preferred embodiment of a linear ratchet according to the present invention;

FIG. 2 is an exploded view of the embodiment of FIG. 1;

FIG. 3 is a sectional view taken along line A-A of FIG. 1 showing the linear ratchet of FIG. 1 in normal operation with its release pin in its normal, locking position;

FIG. 4 is a sectional view taken along line A-A of FIG. 1 showing the release pin in its released position;

FIG. 5 is an enlarged perspective view of one of the latches shown in FIG. 2, and

FIG. 6 is a sectional view of an alternative embodiment which includes first and second groups of latches which are angularly offset from one another by one hundred eighty degrees with respect to the axis of travel of the rack and which span overlapping regions of that axis.

### DETAILED DESCRIPTION

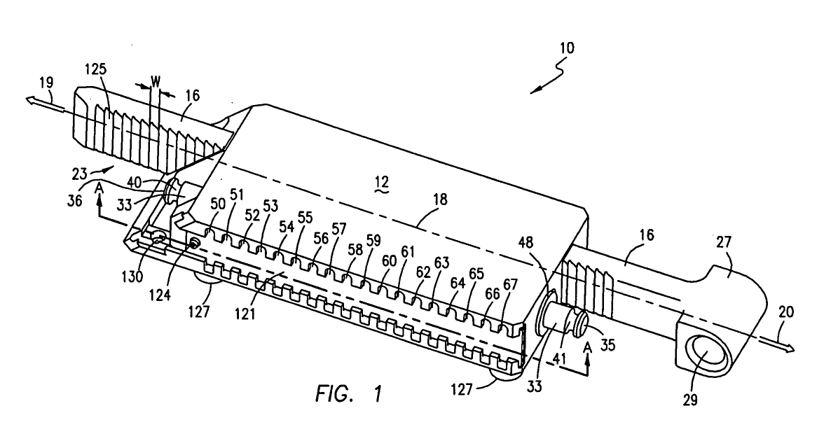

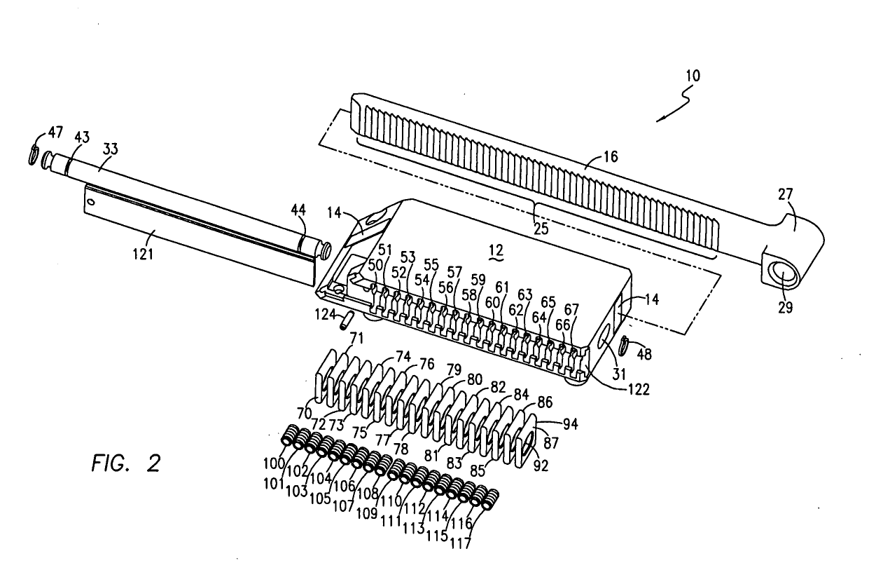

As shown in FIGS. 1 and 2, a preferred embodiment of a linear ratchet 10 according to the invention includes a housing 12 having a first channel 14 of rectangular cross-section passing completely through its length. An elongated rack 16 having a cross-sectional shape corresponding to that of channel 14 is received at least partially inside channel 14. Channel 14 serves to mount rack 16 within housing 12 by orienting and supporting rack 16 for sliding movement relative housing 12 along a linear axis 18 defining a forward direction 19 and an opposite, reverse direction 20. The cross-section of channel 14 is only slightly larger than the corresponding outside cross-sectional dimensions of rack 16 thereby preventing significant movement of rack 16 in any direction other than forward direction 19 or reverse direction 20.

An exterior surface of rack 16 carries a plurality of teeth 23 which are disposed in a linear array 25 extending parallel to axis 18. Each of teeth 23 is of a width dimension, W, as measured in a direction parallel to axis 18. Rack 16 also includes a head 27 which is transected by a cylindrical bore 29 which may receive a pin or other fastener (not shown) for the purpose of coupling rack 26 to some external structure, drive apparatus or other mechanical load which form no part of the invention and are therefore, also not shown.

Housing 12 also includes a second channel 31 which spans the length of housing 12 at a location parallel to channel 14. As most clearly seen from FIG. 2, the cross-sectional profile of channel 31 is elongated in a direction perpendicular to axis 18. Channel 31 receives a release pin 33 having opposed ends 35 and 36 which protrude slightly from housing 12. Ends 35 and 36 include reduced diameter sections 40 and 41 to facilitate attaching ends 35 and 36 to a release wire or other actuator (not shown) for exerting a release force on the ends 35 and 36 of release pin 33 as described in further detail below. Release pin 33 also includes a pair of annular grooves 43 and 44 which receive snap rings 47 and 48 for detachably securing release pin 33 to housing 12.

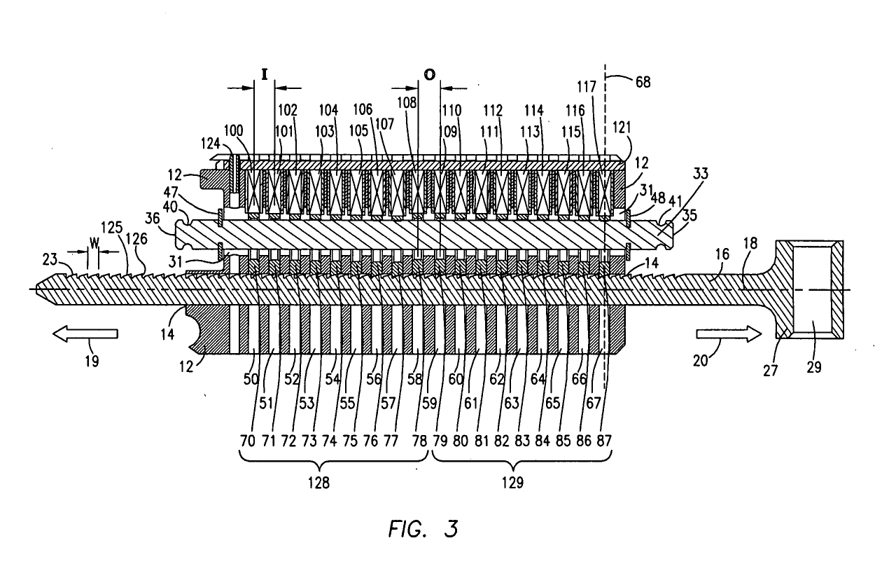

Housing 12 further includes a plurality of mutually-spaced slots 50 through 67. Slots 50-67 are oriented in a direction perpendicular to axis 18 and, as can be seen with additional reference to the sectional view of FIG. 3, transversely intersect channels 14 and 31. Each slot 50-67 defines a linear path 68 which is perpendicular to axis 18. For clarity of illustration, only the particular linear path 68 associated with slot 67 is shown in FIG. 3. It is to be understood, however, that each of the remaining slots 50-66 defines a corresponding path 68, each of which parallels the path 68 shown in FIG. 3. Each of slots 50-67 receives a corresponding one of a plurality of latches, 70 through 87. Slots 50-67 are dimensioned to allow each latch 70-87 to reciprocate within its respective slot 50-67 so as to be capable of linear translation along a portion of a path 68, toward and away from axis 18 on the other hand, slots 50-67 constrain latches 70-87 from moving significantly in either forward direction 19, reverse direction 20 or in either direction normal to the plane of FIG. 3.

As illustrated in FIG. 5, each latch 70-87 has a plate-like body 90 penetrated by an elongated central aperture 92 whose minor dimension is sized to receive release pin 33. Each latch 70-87 has a planar beveled face 94 which adjoins a wall 95 which lies in a plane normal to axis 18 when each latch 70-87 is installed in housing 12. Latches 70-87 are forcibly biased toward axis 18, into contact with the teeth 23 of rack 16. In the preferred embodiment, this is achieved by a series of coil springs 100-117, each of which is captured under compression between a rear face 119 of a respective one of latches 70-87 and a sliding door 121 which is received within a slot 122 formed in housing 12 and secured to housing 12 by a hollow split pin 124. Alternatively, other types of springs, such as leaf springs can be substituted for coil springs 100-117. Linear ratchet 10 can also be readily adapted to use fluid pressure, either liquid or gas, to forcibly bias latches 70-87 into contact with teeth 23 as they are shown in FIG. 3.

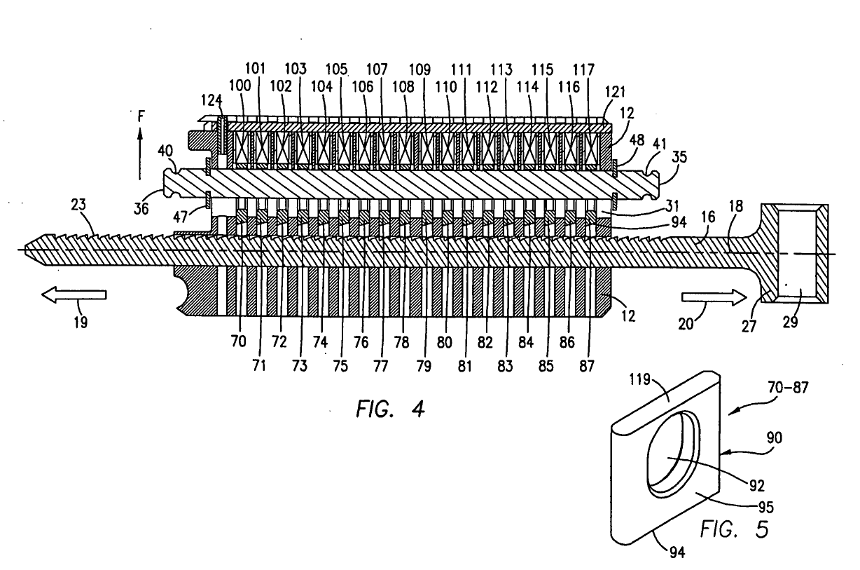

As FIG. 3 shows, release pin 33 passes through the aperture 92 of each of latches 70-87 and is thereby mechanically coupled to each of latches 70-87. Pin 33 thus retains latches 70-87 within their respective slots 50-67. In the event rack 16 is withdrawn from housing 12 a distance sufficient to clear one or more of slots 50-67 such that rack 16 itself no longer prevents latches 70-87 from passing out of the open ends of slots 50-67. Interference between pin 33 and the wall of apertures 92 will retain latches 70-87 within their respective slots 50-67 inside housing 12. Pin 33 also serves as a release member which is mechanically coupled to each of latches 70-87 for selectively engaging latches 70-87 from rack 16 so as to selectively enable movement of rack 16 in reverse direction 20 as will be described below with reference to FIG. 4.

Teeth 23 and latches 70-87 are shaped such that, during normal operation of linear ratchet 10 as illustrated in FIG. 3, teeth 23 and latches 70-87 permit rack 16 to move substantially freely with respect to housing 12 in forward direction 19 but act to arrest movement of rack 16 in reverse direction 20. Reverse movement of rack 16 is limited by establishing shear engagement between at least one of latches 70-87 and at least one of teeth 23. More particularly, in the preferred embodiment, each of teeth 23 has a planar contact surface 125 which is inclined in reverse direction 20. Each of teeth 23 also includes a wall 126 which adjoins the highest edge of contact surface 125 and lies in a plane which is normal to axis 18 when rack 16 is installed in housing 12. The cross-sectional profile of linear array 25 of teeth 23 is generally that of a periodic sawtooth. The beveled face 94 of each one of latches 70-87 is inclined at an angle complementary to that of the contact surfaces 125 of teeth 23 in order to permit the contact surfaces 125 of teeth 23 to slide freely over the beveled faces 94 of latches 70-87 when rack 16 is moved in the forward direction 19. However, when rack 16 is moved in reverse direction 20, a portion of the planar wall 95 of at least one of the latches 70-87 make direct facial contact with the wall 126 of at least one of the teeth 23. That engagement loads both tooth and latch in shear to arrest any further movement of the rack 16 in the reverse direction 20 without slip. To reduce drag between teeth 23 and latches 70-87, the biasing force exerted by springs 110-117 is preferably of as low a magnitude as practical. Also, the beveled front faces 94 of latches 70-87 and the contact surfaces of teeth are preferably provided with smooth surfaces and/or lubrication.

In the preferred embodiment, the contacting walls 126 and 95 of the teeth 23 and latches 70-87, respectively, are preferably parallel to one another as well as to the path 68 along which each latch 70-87 reciprocates. This causes shear engagement to be established substantially simultaneously over the entire region of contact between walls 126 and 95. Movement of rack 16 in reverse direction 20 can thus be resisted with the full reverse load capacity of linear rack 10 from the moment walls 126 and 95 first make contact. Those skilled in the art will appreciate that linear ratchet 10 can be designed to resist movement in reverse direction 20 against a maximum reverse load force whose magnitude can be selected to meet the needs of a particular application by applying conventional mechanical design techniques such as appropriate selection of the dimensions and materials used for load-bearing members.

The resolution of linear ratchet 10 can be tailored to meet the needs of a particular application without diminishing its maximum reverse load capacity. Shear engagement of at least one of teeth 23 with at least one of latches 70-87 takes place to arrest travel of rack 16 in reverse direction 20 in the manner described above when rack 16 travels in reverse direction 20 by not more than a predetermined maximum distance representing the maximum backlash of linear ratchet 10.

In an embodiment in which all of the latches 70-87 are spaced the same distance apart from one another as measured in a direction parallel to axis 18, the maximum backlash distance or resolution, R, of linear ratchet 10 is substantially equal to the width, W, of each of teeth 23, as measured in a direction parallel to axis 18 divided by the number, N, of operative latches present. For example, the embodiment illustrated in FIGS. 1-4 includes eighteen (18) latches, namely latches 70-87. If the width, W, of the teeth 23 on rack 16 is selected as thirty-six thousandths of an inch, (0.036″), the resolution, R, of linear ratchet 10 will be two thousandths of an inch (0.002″) as given by:
R=W÷N Equation 1
In practice, the actual measured resolution of linear ratchet 10 can be expected to depart slightly from the nominal value predicted by Equation 1 depending on factors such as manufacturing tolerances and the influence of thermal expansion.

From Equation 1, it can be appreciated that resolution may be improved, that is maximum backlash decreased, by either decreasing the width, W, of teeth 23 and/or by increasing the number, N, of latches. Modifying the construction of linear ratchet 10 in either or both those respects will therefore improve its resolution in a predictable manner. However, decreasing the width, W, of teeth 23 may tend to decrease the root area of each tooth, thus diminishing its ability to resist shear forces without plastic deformation or fracture. Consequently, for a given choice of fabrication materials, decreasing tooth width, W, could degrade the maximum reverse load capacity of linear ratchet 10. However, the invention affords the option of improving resolution, that is, decreasing the maximum backlash of linear ratchet 10 by simply scaling the design to include additional latches. For example, given teeth 23 of the same 0.036 inch width assumed in the prior example, doubling the number of latches used to thirty-six (36) would provide a nominal resolution of one thousandth of an inch (0.001″) with no decrease in reverse load capacity.

It is possible to space latches 70-87 in a variety of ways that will permit linear ratchet 10 to obey Equation 1 above. The simplest technique is to mutually space latches 70-87 so they are positioned at regular distance intervals as measured in a direction parallel to axis 18, with each interval, I, being equal to an arbitrary positive integer multiple, M, the width, W, of each of the teeth 23 on rack 16, plus or minus a distance equal to the desired resolution. That is:
I=(M*W)±R Equation 2
For example, in a case where a tooth width, W, as measured in a direction parallel to axis 18, is 0.036 inches is determined to provide a resistance to shear forces adequate to meet the reverse load requirements of a given application and a nominal resolution (maximum backlash) of two thousandths of an inch (0.002″) is required, a suitable interval, I, for spacing latches 70-87 would be seventy thousandths of an inch (0.070″), that is:
I=(2*0.036″)−0.002
Thus, every one of latches 70-87 would all be mutually spaced so the center-to-center distance between every latch and the next adjacent latch would be 0.070 inches, as measured in a direction parallel to axis 18. Constructing the linear ratchet 10 in accordance with Equations 1 and 2 with its latches 70-87 all evenly spaced in the manner just described will ensure that when rack 16 is moved in reverse direction 20 a distance not greater than the predetermined resolution, R, one of latches 70-87 will come into shear engagement with one of teeth 23 to arrest rack 16 against any further reverse direction 20 unless and until release pin 33 is actuated to enable such movement.

Alternatively, linear ratchet 10 can be constructed to include two or more groups of latches with an offset spacing between adjacent groups which differs from the latch-to-latch spacing within each group. For example, as indicated in FIG. 3, latches 70-87 can be subdivided into two (2) groups of nine (9) latches each namely a first group 128 consisting of latches 70-78 and a second group 129 consisting of latches 79-87. The latches within each respective group 128 and 129 are located at regular intervals, Ig, as measured in a direction parallel to axis 18 given by:
Ig=(M*W)±r Equation 3
where: M is an arbitrary positive integer multiple, W is the width of each of teeth 23 as measured in a direction parallel to axis 18, and r is the resolution, or maximum backlash distance, associated with an individual group of latches.

The resolution, r, of each group 128 and 129 individually is given by:
r=W÷n Equation 4
where: n is the number of latches within a given group, 128 or 129.

Thus, when rack 16 moves in reverse direction 20 a distance of not greater than r, one of the latches 70-78 in group 128 and one of the latches 79-87 in group 129 will engage one of teeth 23 in shear to prevent any further reverse movement of rack 16. If groups 128 and 129 are positioned with respect to one another such that shear engagement between one of teeth 23 and one of latches 70-78 in group 128 occurs simultaneously with shear engagement between another of teeth 23 and a corresponding one of the latches 79-87 in group 129, the overall resolution of linear ratchet 10 will be equal to the resolution, r, of one of its constituent groups of latches 128 or 129 as given by Equation 3. However, by providing an appropriate offset spacing, O, between adjacent groups of latches, the overall total resolution of linear ratchet 10 can be made to be significantly better than the resolution, r, afforded by any of its individual groups of latches. In particular, the overall total resolution, R_{T}, of linear ratchet 10 can be given by:
R_{T}=r÷G Equation 5
where: G is the number of groups of latches present.

For example, assume that for a linear ratchet 10 as depicted in FIG. 3 having two (2) groups of latches 128 and 129, an overall total resolution, R_{T}, of two thousandths of an inch (0.002″) is desired. From Equation 5, it is determined that the resolution, r, of each of groups 128 and 129 can be four thousandths of an inch (0.004″). Assuming each of teeth 23 has a width, W, of thirty-six thousandths of an inch, (0.036″), the latches 70-78 within group 128 can be mutually spaced at center-to-center intervals, I, of sixty-eight thousandths of an inch (0.068″) as given by Equation 3, that is:
Ig=(2*0.036)−0.004

In like manner, the latches 79-87 making up second group 129 are also located on 0.068″ centers.

In order to coordinate the operation first group 128 and second group 129 to provide linear ratchet 10 with the desired net nominal resolution, the latch-to-latch offset distance, 0, between the last latch 78 in first group 128 and the first latch 79 in second group 129 is determined according to the formula:
O=(M*W)±(r÷G)
Where: M is an arbitrary integer multiple; r is the desired net nominal resolution of linear ratchet 10; and G is the number of groups of latches present.

As suitable center-to-center spacing between latches 78 and 79 could therefore be seventy-four thousandths of an inch, that is:
O=(2*0.036)+(0.004÷2)

In normal operation of linear ratchet 10, as will now be described with reference to FIG. 3, springs 100-117 bear on a rear face 119 of each respective latch 70-87 to forcibly bias latches 70-87 along each respective path 68 toward axis 18. The beveled front face 94 of each of latches 70-87 is urged into contact with the contact surface 125 of those of the teeth 23 of rack 16 which align with the latches 70-87 at any given point of travel of rack 16 along axis 18. When no external release force is applied to release pin 33, release pin 33 remains positioned at or near the end of second channel 31 lying nearest axis 18 as shown in FIG. 3. The second channel 31 through housing 12 and the apertures 92 in each of latches 70-87 penetrated by release pin 33 are each sufficiently elongated in the direction parallel to path 68 to allow the latches 70-87 to linearly translate in both directions along a portion of path 68 as the beveled front faces 94 of latches 70-87 track the profile of the contact surfaces 125 of the teeth 23 as rack 16 moves along axis 18.

As can readily be seen from FIG. 3, latches 70-87 and teeth 23 are shaped such that when rack 16 is moved relative to housing 12 in forward direction 19, teeth 23 slide freely past latches 70-87 without establishing significant shear forces between any of teeth 23 and any of latches 70-87. Thus, in normal operation as illustrated in FIG. 3, linear ratchet 10 permits rack 16 to move with respect to housing 12, under the influence of an external force, with low drag in forward direction 19. However, movement of rack 16 in reverse direction 20 is limited to a predetermined maximum backlash distance, whose value corresponds to the desired resolution of linear ratchet 10 as explained in detail above. Before the travel of rack 16 in reverse direction 20 exceeds that predetermined distance, at least one of teeth 23 establishes shear engagement with at least one of latches 70-87 to arrest any further movement of rack 16 in reverse direction 20. That shear engagement is established when the wall 12 of at least one of teeth 23 moves into direct forced contact with a corresponding one of latches 70-87. In the preferred embodiment, such contact occurs along that portion of the wall 95 of latches 70-87 lying adjacent their beveled front surfaces 94. Any further movement of rack 16 in reverse direction 20 can take place only upon actuation of release pin 33. Once shear engagement between any of latches 70-87 and teeth 23 is established, any external force applied to rack 16 in reverse direction 20 is transferred through housing 12 to whatever external structure housing 12 may be mounted. To facilitate mounting and load transfer, housing 12 may be provided with one or exterior projections 127 or mounting holes 130 as shown in FIG. 1. Exterior projections 127 may be sized to be received securely within apertures formed in external support structure (not shown). If desired, mounting holes 130 may receive screws or other fasteners (not shown) for fastening linear ratchet 10 to such external structure.

As illustrated in FIG. 4, release pin 33 is actuated by selectively applying external force to one, or preferably both, of its ends 35 and 36. This may optionally be facilitated by securing the opposed ends of pin 33 to a rigid or flexible yoke (not shown) affixed to reduced diameter portions 40 and 41 such that applying a release force to one or more locations along the yoke will result in application of force to both ends of pin 33 simultaneously. The resultant release force, F, is oriented orthogonally away from axis 18 and is of a magnitude sufficient to overcome the opposing net biasing force exerted by springs 100-117. Release force, F, moves release pin 33 to engage the end of the aperture 92 in each of latches 70-87 lying furthest from axis 18 and latches 70-87 away from axis 18 a distance sufficient to preclude latches 70-87 from establishing shear engagement with any of teeth 23. Movement of rack 16 in reverse direction 20 is thus enabled. As long as sufficient force is applied to maintain release pin 33 in the release position shown in FIG. 4, rack 16 can travel with respect to housing 12 in either forward direction 19 or reverse direction 20. When the release force is removed from release pin 33, the biasing force exerted by springs 100-117 causes release pin 33 and latches 70-87 to resume their normal operating positions as shown in FIG. 3 and described above.

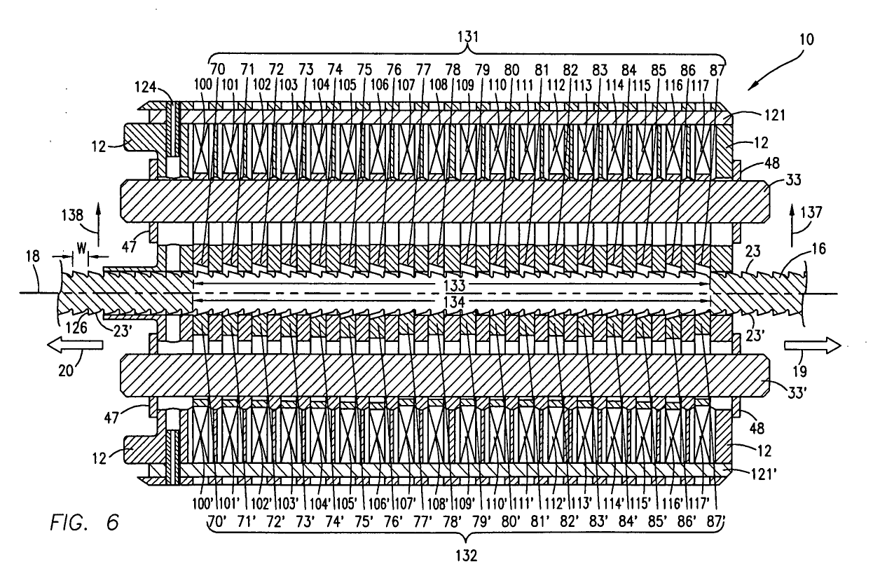

FIG. 6 illustrates, an alternative embodiment of a linear ratchet 10 having which sets of latches are located angularly offset from one another and wherein those sets span at least partially overlapping regions of axis 18. As shown, teeth 23 and 23′ are provided on opposite elongated sides of rack 16. A first set 131 of latches, consisting of latches 70-87, spans a first region 133 of axis 18. Latches 70-87 are mounted in the manner described above in connection with FIGS. 1-4 for engaging teeth 23. Latches 70-87 are forcibly biased toward axis 18 by springs 100-117 captured between the rear faces 119 of latches 70-87 and sliding door 121. A second set 132 of latches consisting of latches 70′-87′ spans a second region 134 of axis 18. The latches 70′-87′ of second sets 132 are mounted in an analogous manner, except that second set 132 is angularly offset from first set 131 with respect to axis 18 by one hundred eighty degrees (180°) to permit latches 70′-87′ to engage teeth 23′. For that purpose, latches 70′-87′ are forcibly biased toward axis 18 by springs 100′-117′ interposed between their rear forces 119 and a second sliding door 121′. Latches 70-87 and 70′-87′ are each of the form described above with reference to FIG. 5. The latches 70-87 of first set 131 are penetrated by a release pin 33 which is mounted and operates in the manner explained above with reference to the embodiment of FIGS. 1-4. A second release pin 33′ is correspondingly mounted with respect to the latches 70′-87′ of the second set 132 and operates in a like manner.

For the sake of illustration, release pin 33′ is shown in FIG. 6 in its normal operating position in which latches 70′-87′ can shearingly engage teeth 23′ to arrest movement of rack 16 in reverse direction 20. In contrast, release pin 33 is shown in its released position, having been moved from its normal operating position by the application of external force in the direction indicated by arrows 137 and 138. To release rack 16 to enable it to move in reverse direction 20 as well as forward direction 19, it will be appreciated that release pins 33 and 33′ must both assume their released positions. With regard to resolution and reverse load capacity, the embodiment of FIG. 6 can be analyzed by first considering the independent contributions of teeth 23 and the first set 131 of latches 70-87 on one hand and the contributions of teeth 23′ and the second set 132 of latches 70′-87′ on the other hand.

Assuming teeth 23 are all of equal width, W, latches 70-87 within first set 131 can be spaced along axis 18 so as to provide a resolution given by Equation 1 above. As described above, one option is to space each of latches 70-87 at equal center-to-center intervals, I, according to Equation 2. Alternatively, latches 70-87 can be divided into two or more groups, such as the groups 128 and 129 described above with reference to FIG. 3, with each group being offset from the next group in a direction parallel to axis 18 by a distance, O, determined according to Equation 5 above. When latches 70-87 are positioned according to one of the options, at least one of latches 70-87 will shearingly engage at least one of one of teeth 23 to arrest movement of rack 16 in reverse direction 20 before movement of rack 16 in direction 20 exceeds the predetermined maximum backlash distance (i.e., resolution) predicted according to Equation 1 or Equation 5. In a case where teeth 23 are also of equal width, W, and latches 70-87 of second set 132 are spaced along axis 18, the same manner as their counterparts in first set 131, at least one of latches 70′-87′ in second set 132 will also engage at least one of teeth 23′ before movement of rack 16 in reverse direction 20 exceeds a predetermined maximum backlash distance identical to that associated with first set 131.

In FIG. 6, each of teeth 23 is shown precisely aligned along axis 18 with a corresponding one of teeth 23′Latches 70-87 are each likewise shown positioned in mirrored alignment across axis 18 with corresponding ones of latches 70′-87′. Thus, in normal operation when rack 16 moves in reverse direction 20, shear engagement between one of latches 70-87 and one of teeth 23 will be established substantially simultaneously with the establishment of shear engagement between a corresponding one of teeth 23′ and latches 70′-87′. Inclusion of the second set 131 of latches 70′-87′ thus doubles the overall maximum reverse load capacity of linear ratchet 10 as compared to the maximum reverse load which could be handled by the first set 131 of latches 70-87 acting above. However, because given ones of latches 70-87 shearingly engage teeth 23 in synchrony with the shear engagement between teeth 23′ and corresponding ones of latches 70′-87′, the overall resolution of the linear ratchet 10 as shown in FIG. 6 is substantially identical to that which either the first set 131 of latches or the second set 132 of latches active above would provide.

If desired, the embodiment of FIG. 6 could be modified to provide improved resolution over the configuration shown in FIG. 6. One way this could be done is by shifting teeth 23′ along axis 18 so as to positionally stagger teeth 23′ with respect to teeth 23 while keeping latches 70-87 axially aligned with latches 70′-87′. For example, if teeth 23′ were shifted in either forward direction 19 or reverse direction 20 relative to teeth 23 by a distance equal to one-half the width, W, of a single tooth, the overall maximum backlash of linear ratchet 10 would be half that of the configuration shown in FIG. 6. The same degree of improvement in resolution could alternatively be achieved by keeping teeth 23 in mirrored alignment across axis 18 with teeth 23′ as shown in FIG. 6 while effectively shifting either, but not both, the first set 131 of latches 70-87 or the second set 132 of latches 70′-87′ in either direction 19 or direction 20 by a distance equal to an integer multiple of one-half the width, W, of a single one of teeth 23. Other modifications are also within the scope of the present invention.

For example, in the embodiment of FIG. 6, it will be noted that the region 133 of axis 18 spanned by latches 70-87 and the region 134 of axis 18 spanned by latches 70′-87′ completely overlap one another. That is, regions 133 and 134 are identical. Such construction minimizes the overall length of linear ratchet 10 along axis 18. However, in applications where that dimension is of less concern, it will be appreciated that latches 70-87 can be offset from latches 70′-87′ such that regions 133 and 134 overlap only partially or, not at all.

By way of further example, in, the embodiment of FIG. 6, teeth 23 and 23′ are provided on opposed elongated faces of rack 16 and latches 70-87 are angularly offset from latches 70′-87′ by one hundred eighty degrees (180°) with respect to axis 18. Variations of the embodiment of FIG. 6 with sets of latches angularly offset from one another with respect to axis 18 at other angles are also possible. For instance, in light of the present disclosure, those of ordinary skill in the art will appreciate that instead of being of rectangular cross-section, rack 16 could alternatively have a triangular cross-section and carry a set of teeth 23 along each of its three elongated sides. In the case of a rack 16 having a cross-sectional profile in the shape of an equilateral triangle, three sets of latches, each angularly offset from one another by one hundred twenty degrees (120°) with respect to axis 18 could be provided juxtaposed respective ones of the three sets of teeth 23.

While the foregoing constitute certain preferred and alternative embodiments of the present invention, it is to be understood that the invention is not limited to the embodiments described. In light of the present disclosure, various other embodiments will be apparent to persons skilled in the art. Accordingly, it is to be recognized that changes can be made without departing from the scope of the invention as particularly pointed out and distinctly claimed in the appended claims which are to be construed to encompass all legal equivalents thereof.

1. A linear ratchet apparatus, comprising:
a rack mounted for linear movement along an axis, said axis defining a forward direction and a reverse direction, said rack carrying a plurality of teeth in a linear array extending parallel to said axis;
a plurality of latches mutually spaced from one another in a direction parallel to said axis, each of said latches being mounted for linear translation toward and away from said axis, and
force biasing means mechanically coupled to said latches for forcibly biasing each of said latches toward said axis into contact with said teeth, said teeth and said latches being shaped to (i) permit movement of said rack in said forward direction and to (ii) arrest movement of said rack in said reverse direction by establishing shear engagement between at least one of said latches and at least one of said teeth.

2. The linear ratchet apparatus of claim 1 wherein each of said teeth has a width measured in said direction parallel to said axis and wherein said latches are positioned at intervals measured in said direction parallel to said axis, said width, said intervals, and the number of said latches included in said plurality of latches being such that, upon movement of said rack in said reverse direction by not more than a predetermined maximum distance, said at least one of said latches establishes shear engagement with at least one of said teeth to arrest said movement of said rack in said reverse direction.

3. The linear ratchet apparatus of claim 2 wherein said predetermined maximum distance is substantially equal to said width divided by the number of said latches included in said plurality of latches.

4. The linear ratchet apparatus of claim 2 wherein each of said intervals substantially equal to a multiple of said width plus said predetermined maximum distance, said multiple being an integer multiple.

5. The linear ratchet apparatus of claim 2 wherein each of said intervals is substantially equal to a multiple of said width minus said predetermined maximum distance, said multiple being an integer multiple.

6. The linear ratchet apparatus of claim 1 wherein each of said latches is mounted for said linear translation along a path which is oriented substantially perpendicular to said axis.

7. The linear ratchet apparatus of claim 1 wherein said force biasing means comprises at least one spring.

8. The linear ratchet apparatus of claim 1 further, comprising:
a release member mechanically coupled to each of said latches for applying force to said release member sufficient to overcome said force biasing means, whereby upon applying said force to said release member, said latches can be selectively moved away from said axis a distance sufficient to prohibit said shear engagement of said at least one of said latches with said at least one of said teeth to enable movement of said rack in said reverse direction.

9. The linear ratchet apparatus of claim 8 wherein each of said latches includes an aperture and said release member comprises a pin passing through each said aperture.

10. A linear ratchet apparatus, comprising:
a rack mounted for linear movement along an axis, said axis defining a forward direction and a reverse direction, said rack carrying a plurality of teeth disposed in a linear array extending parallel to said axis;
a first set of latches, said latches in said first set being mutually spaced from one another in a direction parallel to said axis, each of said latches in said first set being mounted for movement toward and away from said axis;
a second set of latches, said latches in said second set being mutually spaced from one another in said direction parallel to said axis, each of said latches in said second set being mounted for movement toward and away from said axis, and said second set of latches being angularly offset from said first set of latches with respect to said axis; and
force biasing means mechanically coupled to said latches for forcibly biasing each of said latches toward said axis and into contact with said teeth, said teeth and said latches being shaped so to (i) permit movement of said rack in said forward direction and to (ii) arrest movement of said rack in said reverse direction by establishing shear engagement between at least one of said latches and at least one of said teeth.

11. The linear ratchet of claim 10 wherein said first set of latches spans a first region of said axis and said second set of latches spans a second region of said axis; said first region and said second region at least partially overlapping one another.

12. The linear ratchet apparatus of claim 10 wherein each of said latches is mounted for said linear translation along a path which is oriented substantially perpendicular to said axis.

13. The linear ratchet apparatus of claim 10 wherein said force biasing means comprises at least one spring.

14. The linear ratchet apparatus of claim 10 further, comprising:
a release member mechanically coupled to each of said latches for applying a force to said release member sufficient to overcome said force biasing means, whereby upon applying said force to said release member, said latches can be selectively moved away from said axis a distance sufficient to release said at least one of said latches from engagement with said at least one of said teeth to enable movement of said rack in said reverse direction.

15. The linear ratchet apparatus of claim 14 wherein each of said latches includes an aperture and said release member comprises a pin passing through each said aperture.

16. A linear ratchet apparatus, comprising:
a housing;
a rack received at least partially within said housing and mounted for linear movement with respect to said housing along an axis, said axis defining a forward direction and a reverse direction, said rack carrying a plurality of teeth in a linear array extending parallel to said axis;
a plurality of latches mutually spaced from one another in a direction parallel to said axis, each of said latches being mounted for linear translation toward and away from said axis, and
force biasing means mechanically coupled to each of said latches for forcibly biasing each of said latches toward said axis into contact with said teeth, said teeth and said latches being shaped so to (i) permit movement of said rack in said forward direction and to (ii) arrest movement of said rack in said reverse direction by establishing shear engagement between at least one of said latches and at least one of said teeth.

17. The linear ratchet apparatus of claim 16 wherein each of said teeth has a width measured in said direction parallel to said axis and wherein adjacent ones of said latches are positioned at intervals measured in said direction parallel to said axis, said width, said intervals and the number of said latches included in said plurality of latches being such that, upon movement of said rack in said reverse direction by not more than a predetermined maximum distance, said at least one of said latches establishes shear engagement with at least one of said teeth to arrest said movement of said rack in said reverse direction.

18. The linear ratchet apparatus of claim 16 wherein said predetermined maximum distance is substantially equal to said width divided by the number of said latches included in said plurality of latches.

19. The linear ratchet apparatus of claim 16 wherein each of said intervals is substantially equal to a multiple of said width plus said predetermined maximum distance, said multiple being a positive integer multiple.

20. The linear ratchet apparatus of claim 16 wherein each of said intervals is substantially equal to a multiple of said width minus said predetermined maximum distance, said multiple being a positive integer multiple.

21. The linear ratchet apparatus of claim 16 wherein each of said latches is mounted for said linear translation along a path which is oriented substantially perpendicular to said axis.

22. The linear ratchet apparatus of claim 16 wherein said force biasing means comprises at least one spring.

23. The linear ratchet apparatus of claim 16 further, comprising:
a release member mechanically coupled to each of said latches for applying force to said release member sufficient to overcome said force biasing means, whereby upon applying said force to said release member, said latches can be selectively moved away from said axis a distance sufficient to release said at least one of said latches from engagement with said at least one of said teeth to enable movement of said rack in said reverse direction.

24. The linear ratchet apparatus of claim 23 wherein each of said latches includes an aperture and said release member comprises a pin passing through each said aperture.

25. A linear ratchet apparatus, comprising:
a housing;
a rack received at least partially within said housing and mounted for linear movement with respect to said housing along an axis, said axis defining a forward direction and a reverse direction, said rack carrying a plurality of teeth disposed in a linear array extending parallel to said axis;
a first set of latches spanning a first region of said axis, said latches in said first set being mutually spaced from one another in a direction parallel to said axis, each of said latches in said first set being mounted for movement toward and away from said axis;
a second set of latches spanning a second region of said axis, said latches in said second set being mutually spaced from one another in said direction parallel to said axis, each of said latches in said second group being mounted for movement toward and away from said axis, and said first set of latches of said axis being angularly offset from said second set of latches with respect to said axis, and said first region and said second region at least partially overlapping one another; and
force biasing means mechanically coupled to said latches for forcibly biasing each of said latches toward said axis and into contact with said teeth, said teeth and said latches being shaped so to (i) permit movement of said rack in said forward direction and to (ii) arrest movement of said rack in said reverse direction by establishing shear engagement between at least one of said latches and at least one of said teeth.
